(19) United States
(12) Patent Application Publication
(10) Pub. No.: US 2025/0319407 A1
(43) Pub. Date: Oct. 16, 2025

(54) PERFORMANCE DRIVEN SKILL-NODE RECOMMENDER FOR VIRTUALIZED GAMING ENVIRONMENTS

(71) Applicant: Riot Games, Inc., Los Angeles, CA (US)

(72) Inventors: Edward Tian Ren MA, Palomar Park, CA (US); Bryan Matthew O'Malley, Cupertino, CA (US); Anouk Ben-Tchavtchavadze, Pacifica, CA (US)

(21) Appl. No.: 18/637,128

(22) Filed: Apr. 16, 2024

(51) Int. Cl. A63F 13/67; A63F 13/798

(52) U.S. Cl. CPC A63F 13/67; A63F 13/798

(57) ABSTRACT

Systems, methods, and media are provided for skill-based training in video games. Skill nodes are provided, each skill node corresponding to a gameplay skill. Gameplay events are detected in gameplay data and analyzed to determine a player's progress with respect to a selected skill node. Based on the player's progress, the skill node can progress to a subsequent state in which additional statistics are presented to the player. The gameplay data is also analyzed to provide replays and textual advice relevant to the skill node.

### BACKGROUND

The tutorials, instructions, and other training features of traditional software programs (e.g., video games) are designed to equip users with basic knowledge of the software. For example, video game tutorials are designed to equip players with basic gameplay knowledge. However, such tutorials often leave critical gaps in players' gameplay abilities, fail to provide ways for players to meaningfully improve within the gameplay context, are not engaging, or suffer from a combination of these problems. These shortcomings can result in player attrition, frustration, and negative gameplay experiences, among other consequences.

### SUMMARY

Embodiments of the present disclosure relate to skill-based training in video games. As a player competes in gameplay matches, gameplay data for the player is tracked and analyzed. Skill-specific feedback is presented to the player based on the gameplay data—e.g., in the form of “skill nodes.” The skill nodes display different analyses of the player's gameplay data as the player improves their gameplay skills, which helps players identify gameplay skills at which they can improve. Additionally, gameplay replays and/or textual gameplay advice can be generated and presented to the player. The replays and/or textual advice can correspond to specific gameplay skills selected by the player, thus providing the player with further avenues through which to improve their skills.

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

### BRIEF DESCRIPTION OF THE DRA WINGS

The present technology is described in detail below with reference to the attached drawing figures, wherein:

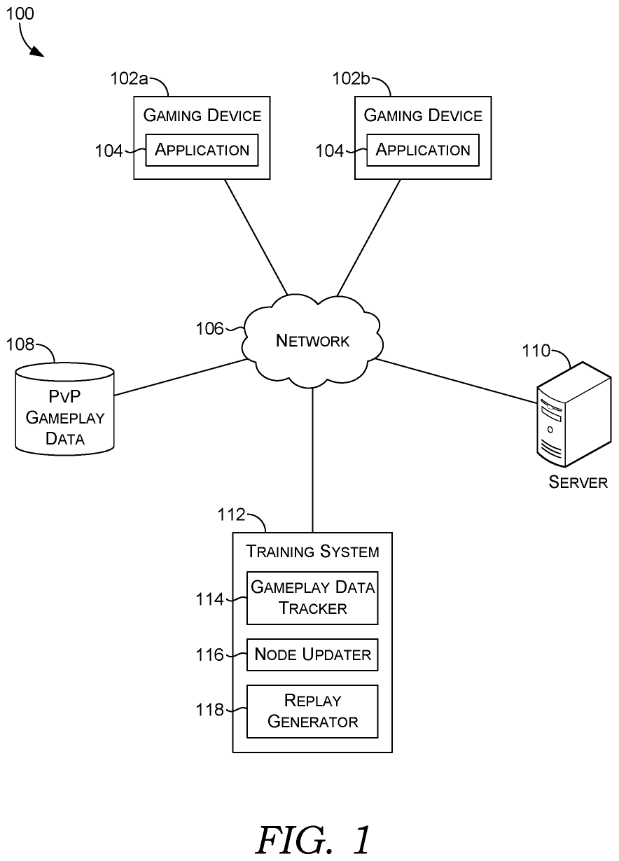

FIG. 1 is a block diagram illustrating an example system, in accordance with some embodiments described herein;

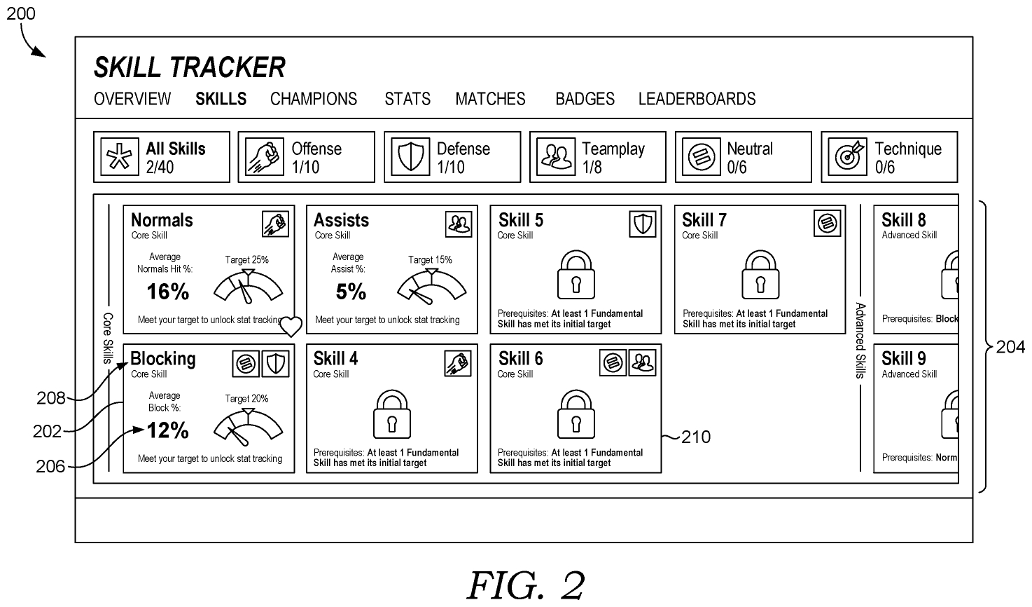

FIG. 2 is an example user interface comprising a plurality of skill nodes in accordance with some embodiments described herein;

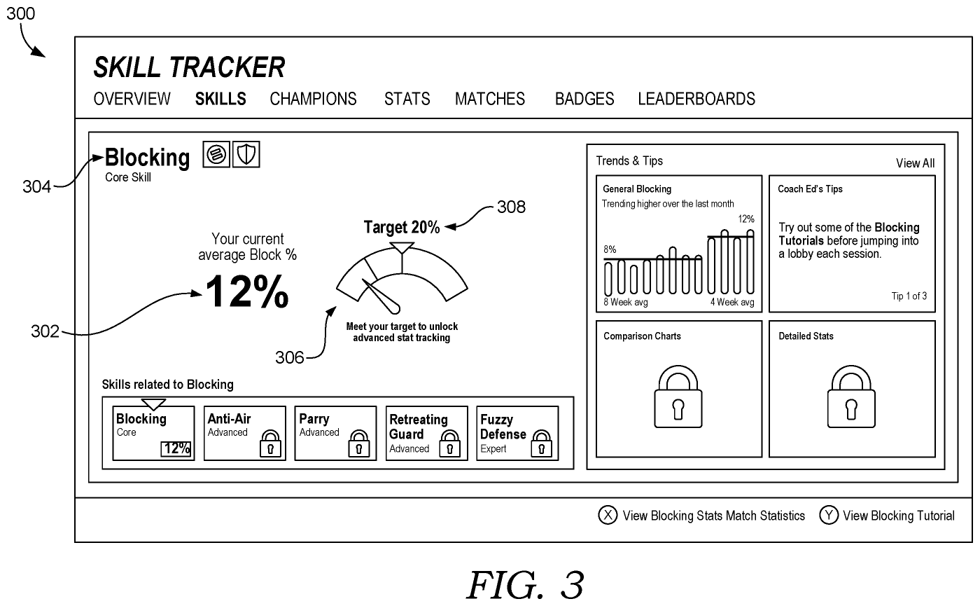

FIG. 3 is an example user interface for displaying information related to a skill node in accordance with some implementations described herein;

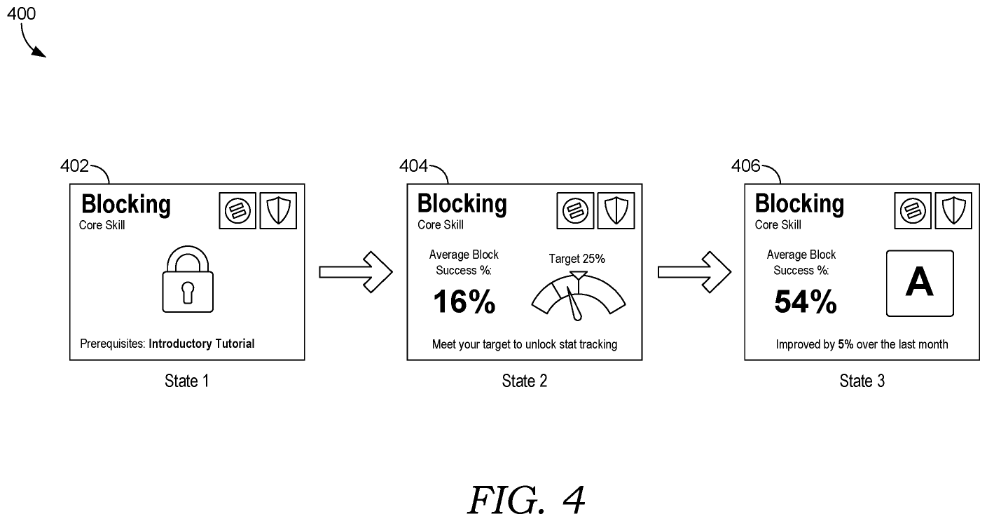

FIG. 4 illustrates an example progression between states of a skill node in accordance with some embodiments described herein;

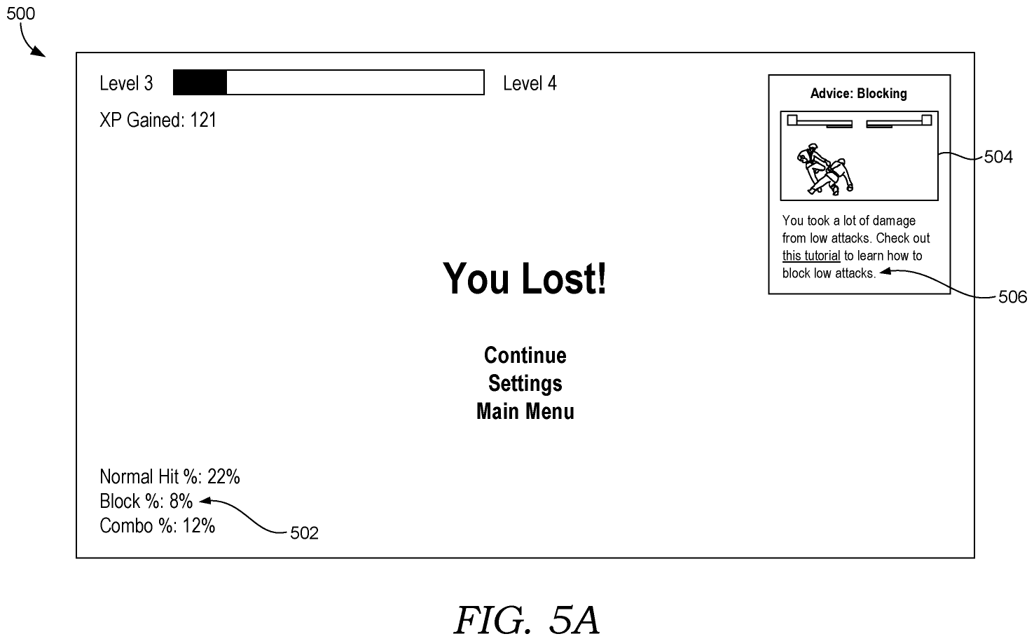

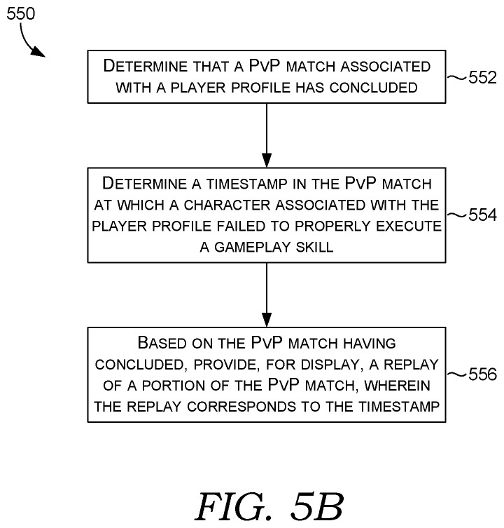

FIG. 5A is an example post-match user interface in accordance with some embodiments described herein;

FIG. 5B is a flow diagram showing a methods of providing a replay of PvP gameplay in accordance with some embodiments described herein;

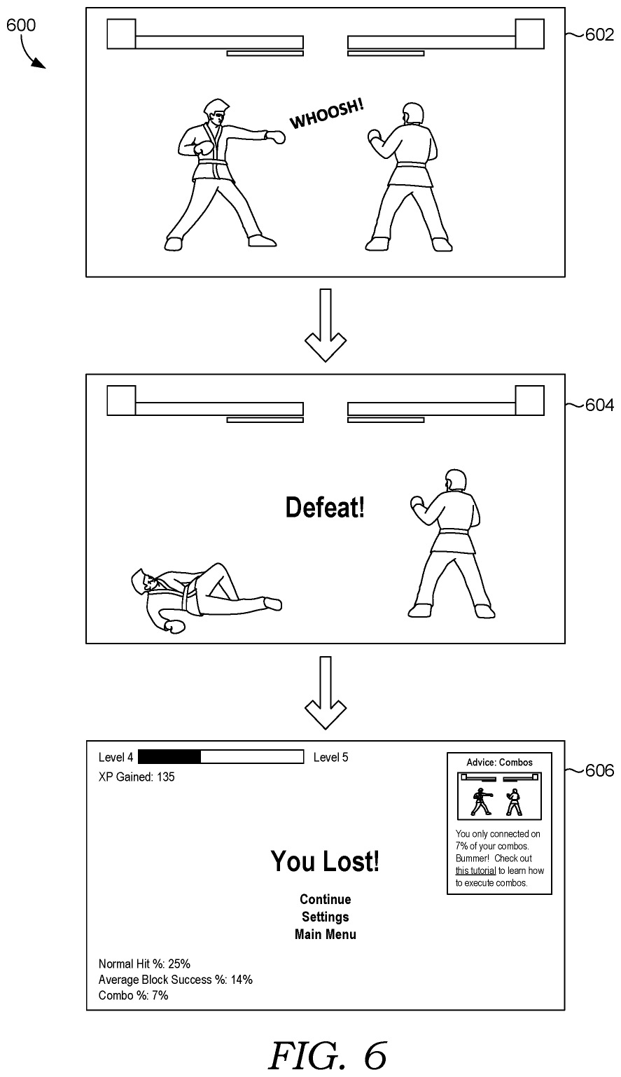

FIG. 6 illustrates an example process for providing feedback related to a gameplay skill in accordance with some embodiments described herein;

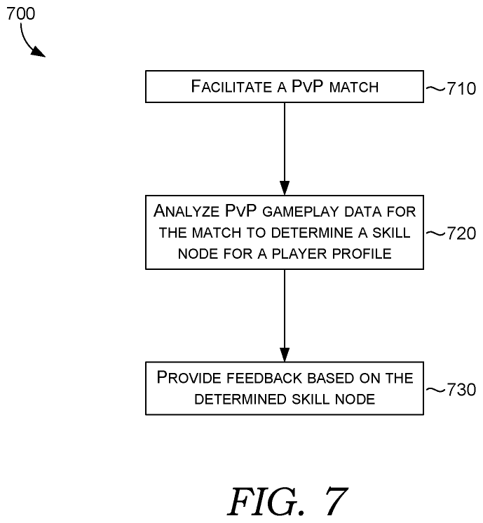

FIG. 7 is a flow diagram showing methods of analyzing and providing feedback on PVP gameplay in accordance with some embodiments described herein; and

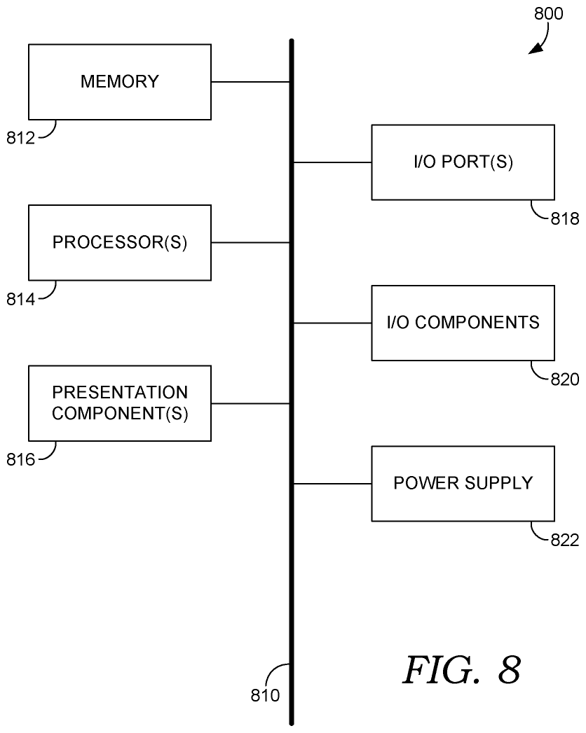

FIG. 8 is a block diagram of an example computing environment suitable for use in embodiments described herein.

### DETAILED DESCRIPTION

Many video games include training methods, such as tutorials, that aim to teach players basic gameplay skills in a useful, engaging manner. Most video games fail at this task. Traditional training methods are unengaging, one-size-fits-all slogs that leave players with critical skill gaps. For example, traditional game tutorials are presented as a video, series of text boxes, or as a series of in-game challenges that gate gameplay behind successful completion of the mechanic currently being tested.

The player may be forced to initiate the game tutorial as the first gameplay activity. After initiation of the tutorial, the player may be forced to go a procession of instructions. For example, a tutorial in a multiplayer online battle arena (MOBA) may explain how to activate each type of player ability, how to acquire items, how to use the mini-map, how to move the player controlled player, how to understand status effect indicators, where resource indicators (e.g., health bar, mana bar, current gold amount) are in the UI are located, where player-to-player communications are displayed in the UI, and so forth. For another example, a tutorial for an action role-playing game (aRPG) may explain how to jump, dodge, block, parry, attack, move, heal, expend experience points, equip items, use items, and so forth. For yet another example, a tutorial for a real time strategy (RTS) game may explain different unit types and their roles, what the resources are and how to collect them, what each building type facilitates and how to build them, how to access and use a technology tree, how to access unit production queue, how to select a unit, how to move a unit, how to attack move a unit, how to queue unit movements, and so forth.

Even if a player is familiar with the genre of game, the player often has little contextual understanding of the particular game and the tutorial often does not provide it. Said differently, the instruction is often provided in the absence of the context to understand when or why a specific game mechanic should be used. One illustrative, non-limiting example is player-versus-player (PvP) fighting games. Fighting games are extremely fast paced; attacks are often executed in rapid succession, and conditions can change in a fraction of a second. Many fighting games also imbue their mechanics (e.g., attack types) with visual styles that make the mechanics difficult for players to visually identify and assign unintuitive hitboxes to digital objects (e.g., characters). To make matters worse, fighting games commonly utilize a one-versus-one (1v1) format; there are typically no (or few) teammates to blame for losses. Thus, if a fighting game fails to teach a player an important skill, causing the player's performance to suffer, the player is likely to become frustrated and may stop playing the game. Said yet another way, traditional training methods in games may explain the tools available to the player but do not train the skills to use the tools effectively. Players are instead forced to learn most skills through trial and error in a non-tutorial setting, which can be frustrating and drive up player attrition.

As such, various embodiments of the present disclosure are directed to systems, methods, and media for skill-based training in video games, including, but not limited to, fighting games. Some aspects of the present disclosure are drawn to “skill nodes,” each skill node representing a gameplay skill (e.g., “blocking” or “normal attacks”). A player can select a skill node corresponding to a gameplay skill at which they would like to improve. In some aspects, each skill node comprises a plurality of states. A skill node progresses from one state to the next when the player reaches a threshold level of proficiency with respect to the gameplay skill. The player's level of proficiency can be determined from an analysis of the player's gameplay data. For instance, a “blocking” skill node may progress from a first state to a second state if the player has successfully blocked at least 15% of their opponents' attacks in the player's last 30 matches. As a skill node progresses between states, the node can display additional statistics, targets, and so on to encourage the player to master the gameplay skill. The player can also be awarded badges or achievements for advancing a node to a particular state. Among other benefits, this approach improves existing training methods by incentivizing players to focus on improving specific gameplay skills in a straightforward, rewarding, and self-guided manner.

Presenting players with discrete, selectable skill nodes comprising pre-generated gameplay statistics may avoid computationally expensive alternatives. For example, in some traditional video games, servers and/or player devices analyze large volumes of raw gameplay data in order to identify potential areas of player improvement. Similarly, some embodiments herein analyze players' gameplay by looking at gameplay events detected during gameplay. This obviates the need to (a) reconstruct an entire game from raw gameplay data and/or (b) record gameplay using a screen-recording application—both of which are computationally expensive.

Additionally, in some embodiments, a player can “select” a skill node of interest. As described in more detail below, selection can cause information relevant to the skill node—such as statistics, gameplay trends, match replays, and textual advice—to be automatically presented to the player in a post-match user interface. As such, the player need not navigate through menus in order to obtain desired skill-related information.

In additional aspects, match replays related to a selected skill node (and/or the corresponding gameplay skill) are generated and provided. Such embodiments can afford players the ability to efficiently review and learn from mistakes in their own games. In order to generate a replay, unsuccessful executions of the gameplay skill can be identified in gameplay data for a match. A replay of a portion of the match corresponding to the unsuccessful skill execution can be automatically rendered. In some aspects, the replay can be presented to the player in a post-match user interface. As such, the server need not render a replay of an entire match-just the portion(s) (i.e., subsets) of the match corresponding to failures to execute the gameplay skill (for instance). This approach avoids the substantial computation required to render a full-match replay.

Similarly, the gameplay data may be analyzed to determine potential areas of improvement in the player's gameplay. Gameplay events and gameplay data may be derived from any aspect of the game. For example, gameplay data may be detected from local gameplay matches (e.g., a match hosted on the local gaming device), networked gameplay matches (e.g., a match hosted on a remote server), gameplay exercises, training matches (e.g., a player against a computerized opponent), training challenges, or any combination thereof. Textual feedback may be generated based on the analysis and presented to the user—e.g., in the post-match user interface and/or the corresponding skill node.

The computational costs avoided by these embodiments represent significant technical improvements. For example, queries to raw gameplay data—and the corresponding analysis—that would be conducted in the absence of the present embodiments may result in substantial costs to computer networks, such as repetitive, high-volume data transmission and/or query processing. Moreover, the computational costs outlined above, including menu navigation and rendering, data analysis, query processing, and video rendering, increase storage device I/O (e.g., excess physical read/write head movements on a non-volatile disk) because each these computational costs are incurred, the computing system has to reach out to the storage device to perform a read or write operation, which is time consuming, error prone, and may eventually wear on components, such as a read/write head.

With reference now to the figures, FIG. 1 depicts an example system 100 for providing training related to gameplay skills, in accordance with the embodiments described herein. It should be understood that this and other arrangements described herein are set forth only as examples. Other arrangements and elements (e.g., machines, interfaces, functions, orders, and groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

Generally, system 100 provides network architecture that may facilitate implementation of aspects described herein. The system 100 includes a first gaming device 102a, a second gaming device 102b, a gaming server 110, a training system 112, and a datastore 108. Each of the first gaming device 102a, the second gaming device 102b, the gaming server 110, the training system 112, and the datastore 108 shown in FIG. 1 may comprise one or more computer devices, such as the computing device 800 of FIG. 8, discussed below. As shown in FIG. 1, the first gaming device 102a, the second gaming device 102b, the gaming server 110, the training system 112, and the datastore 108 may communicate via a network 106, which may include, without limitation, one or more local area networks (LANs) and/or wide area networks (WANs). Such networking environments are commonplace in offices, enterprise-wide computer networks, intranets, and the Internet. It should be understood that any number of client devices and server devices may be employed within the system 100 within the scope of the present technology. Each may comprise a single device or multiple devices cooperating in a distributed environment. For instance, the training system 112 may be provided by multiple server devices collectively providing the functionality of the training system 112 as described herein. Additionally, other components not shown may also be included within the network environment.

The first gaming device 102a and second gaming device 102b (collectively referred to as the gaming devices 102) may be client devices on the client side of operating environment 100. The training system 112 may be on the server side of operating environment 100. The training system 112 may comprise server-side software designed to work in conjunction with client-side software on the gaming devices 102 to implement any combination of the features and functionalities discussed in the present disclosure. For instance, the gaming devices 102 may each include an application 104 for interacting with the training system 112. The application 104 may be, for instance, gaming software, a web browser, or any other dedicated application for providing functions, such as those described herein. This division of operating environment 100 is provided to illustrate one example of a suitable environment, and there is no requirement for each implementation that any combination of the gaming devices 102 and the training system 112 remain as separate entities. While the operating environment 100 illustrates a configuration in a networked environment with separate gaming devices 102 and a separate training system 112, it should be understood that other configurations may be employed in which components are combined. For instance, in some configurations, such as when a user creates a local (e.g., split-screen) match or gameplay instance on a gaming device, only one gaming device may be required. Moreover, in some embodiments, a gaming device may also provide capabilities of the technology described in association with the training system 112.

The gaming devices 102 may comprise any type of computing device capable of facilitating computerized gameplay. For example, in one aspect, the gaming devices 102 may be the type of computing device 800 described in relation to FIG. 8 herein. By way of example and not limitation, each gaming device 102 may be embodied as a personal computer (PC), a gaming console, a laptop computer, a mobile or mobile device, a smartphone, a tablet computer, a smart watch, a wearable computer, an MP3 player, a global positioning system (GPS) or device, a video player, a handheld communications device, an entertainment system, a vehicle computer system, an embedded system controller, a remote control, an appliance, a consumer electronic device, a workstation, or any combination of these delineated devices, or any other suitable device. A user may be associated with the gaming device(s) 102 and may interact with the training system 112 via the gaming device(s) 102.

At a high level, the training system 112 may be related to (e.g., incorporated into) a video game, such as a player-versus-player (PvP) combat (e.g., fighting) game played locally and/or over the internet. The gaming server 110 may connect to the gaming device(s) 102 over the network 106 and facilitate PVP matches. The matches may occur synchronously and in real time. The gaming devices 102 may display (or provide for display) a two-dimensional, three-dimensional, and/or isometric environment comprising at least two adversarial characters controlled via inputs received at/from the gaming device(s) 102. Over the course of a match, gameplay data 108 may be recorded in a gameplay log. The gameplay log may be stored in the datastore 108. Upon conclusion of a match, the training system 112 may analyze the gameplay data 108 corresponding to the match. The analyzed data may be used to provide corresponding gameplay feedback to each player (e.g., at the players' respective gaming devices 102). For example, the training system 112 may provide a replay of an instructive moment in the match and/or provide textual advice. The training system 112 may also analyze a player's gameplay data 108 from multiple matches and provide gameplay skill-specific statistics and advice via “skill nodes,” as discussed in more detail below.

As shown in FIG. 1, the training system 112 includes a gameplay data tracker 114, a node updater 116, and a replay generator 118. The components of the training system 112 may be in addition to other components that provide further additional functions beyond the features described herein. The training system 112 may be implemented using one or more server devices, one or more platforms with corresponding application programming interfaces, cloud infrastructure, and the like. While the training system 112 is shown separate from the gaming device(s) 102 in the configuration of FIG. 1, it should be understood that in other configurations, some or all of the functions of the training system 112 may be provided on the gaming device(s) 102.

In one aspect, the functions performed by components of the training system 112 are associated with one or more applications, services, or routines. In particular, such applications, services, or routines may operate on one or more user devices or servers, be distributed across one or more user devices and servers, or be implemented in the cloud. Moreover, in some aspects, these components of the training system 112 may be distributed across a network, including one or more servers and client devices, in the cloud, can reside on a user device (e.g., a gaming device), or any combination thereof. Moreover, these components, functions performed by these components, or services carried out by these components may be implemented at appropriate abstraction layer(s) such as the operating system layer, application layer, hardware layer, etc., of the computing system(s). Alternatively, or in addition, the functionality of these components and/or the aspects of the technology described herein may be performed, at least in part, by one or more hardware logic components. For example, and without limitation, illustrative types of hardware logic components that may be used include field-programmable gate arrays (FPGAs), application-specific integrated circuits (ASICs), application-specific standard products (ASSPs), system-on-a-chip systems (SOCs), complex programmable logic devices (CPLDs), etc. Additionally, although functionality is described herein with regards to specific components shown in example system 100, it is contemplated that in some aspects, functionality of these components may be shared or distributed across other components.

With reference now to FIG. 2, a user interface (UI) 200 comprising a plurality of skill nodes 204 is provided. The user interface 200 may be provided by the training system 112 at the gaming device(s) 102 and/or on the application 104. At a high level, each of the plurality of skill nodes 204 in the user interface 200 corresponds to a gameplay skill. The user interface 200 may provide, for each of the skill nodes 204, information regarding a user's performance in matches with respect to that skill. For instance, as shown in FIG. 2, a skill node (e.g., 202) may display a success rate 206 associated with the skill 208. The success rate 206 can, for example, be a percentage of attempts to execute the gameplay skill that were successful. Said differently, success rate 206 may be the percentage that a player provided the inputs that convert to a gameplay action that results in successfully executed action. To illustrate, the success rate 206 can indicate that a user successfully blocked 12% of opponents' attacks. Methods for tracking and analyzing gameplay data 108 for a given skill node are discussed in more detail below in regard to FIG. 3.

Examples of gameplay skills may include, without limitation: blocking (e.g., blocking low, cross-up, and/or wake-up attacks), normal attacks (e.g., during neutral, after blocking, or after recovery from an attack), combination attacks (e.g., combos that involve at least a certain number of successful consecutive hits or combos that require successful hits from each of a plurality of characters on a team), teammate saving (e.g., tagging out a teammate who is low on health or interrupting an attack on a teammate), anti-air ability (e.g., blocking or avoiding air-based attacks), punishing (e.g., attacking successfully when an opponent misses an attack), and/or avoiding offensive sequence repetition (i.e., attempting non-repetitive attack types). These are merely examples, and it is contemplated that additional or alternative gameplay skills may be implemented and tracked without departing from the present disclosure. The particular set of gameplay skills may depend, for example, on a game's genre. For instance, in a first-person shooter (FPS) game, many of the aforementioned gameplay skills may be inapplicable, so skill nodes may instead comprise gameplay data regarding gameplay skills such as headshots, ability usage, spray transfer, fight selection, economy, and/or trading teammate deaths, to name a few.

Each skill node 204 comprises a plurality of sequential node states. In some aspects, in a first state, a node (see, e.g., node 210) is initially locked until one or more prerequisites are satisfied. Once the prerequisites are satisfied, the node is “unlocked” (state two). Once unlocked, node-specific statistics are displayed (see, e.g., node 202). At a certain level of mastery (e.g., once a success rate for the corresponding gameplay skill reaches a threshold), the node may enter a third state. In the third state, additional metrics may be displayed. Additional details regarding node states are provided below with reference to FIG. 4.

A selection (or “activation”) of a skill node 204 may be received at/from a gaming device 102 (e.g., via the application 104). A skill node 204 may be selected manually (e.g., by a user via a gaming device 102) or automatically (e.g., by the application 104 and/or gaming server 110). Selection of a skill node 204 may cause any of the following to be displayed in the user interface 200 and/or in a match-summary UI (see FIG. 5A): a player's statistical progress (e.g., success rate) for the skill node; achievements and/or skill badges for the skill node; automatically-generated advice regarding the skill node; and/or skill-specific match replays for the skill node. Additionally or alternatively, a training (e.g., tutorial) module of the video game may provide a visual indication of and/or recommendation for lessons (e.g., tutorials) related to the selected skill node.

Turning now to FIG. 3, a user interface 300 for a skill node (e.g., the skill node 202 of FIG. 2) is provided. As discussed, each skill node—including the skill node illustrated in FIG. 3—corresponds to a gameplay skill. Each skill node also has a corresponding user interface (e.g., the user interface 300) in which related information is displayed.

Among other things, the user interface 300 may display a player's success rate 302 for the gameplay skill 304 to which the skill node corresponds. The node updater 116 may determine the success rate based on gameplay data 108.

Gameplay data 108 is tracked by the gameplay data tracker 114. During a match, gameplay data 108 for the match may be tracked and/or stored in the datastore 108. The gameplay data 108 may comprise gameplay events of the match. A gameplay event may be any action or interaction that takes place during the match, such as a successful or unsuccessful attack, block, and so on. A gameplay event may be detected using any suitable method. For example, a “successful attack” gameplay event may be detected by receiving inputs from one or more gaming devices 102 and determining, based on the received inputs, that a first player's character executed an attack within a hitbox corresponding to a second player's character. A gameplay event may be indexed or labeled based on the timestamp (e.g., frame or step) at which it occurs and/or based on the players or characters involved (e.g., “0:31.4: Player A blocks Player B's low attack”).

The node updater 116 may retrieve gameplay data 108 regarding gameplay events for a player profile that are associated with the gameplay skill 304. In some aspects, the node updater 116 only retrieves gameplay data 108 from a number of most-recent games associated with the player profile (e.g., the player's last 30 games). The node updater 116 determines a success rate 302 for the gameplay skill 304 from the retrieved gameplay data. The node updater 116 may also cause display of the success rate 302 in the user interface 300 (e.g., at the application 104).

To illustrate, FIG. 3 shows a user interface 300 for a gameplay skill 304 (i.e., blocking). During (or after) matches in which a user associated with a user profile participates, gameplay events are detected and stored in the datastore 108. For instance, the gameplay data tracker 114 may detect that Player A blocked Player B's attack; in other instances, the gameplay data tracker may detect that Player A failed to block Player B's attack. In some embodiments, the gameplay data tracker 114 detects a successful block by (a) receiving or identifying an input (e.g., a keypress) that causes an in-game character to execute a blocking maneuver and (b) determining that the in-game character, when executing the blocking maneuver, successfully blocked an enemy character's attacking maneuver. Similarly, in some embodiments, the gameplay data tracker 114 detects an unsuccessful block by (a) receiving or identifying an input (e.g., a keypress) that causes an in-game character to execute a blocking maneuver and (b) determining that, in a window of time (or frames) proximate to when the character executed the blocking maneuver (e.g., +/−1 second from the time the input was received), the character failed to block the attack.

Based on the successful and unsuccessful blocks detected by the gameplay data tracker 114, the node updater 116 may determine a success rate 302 for the “blocking” skill. The success rate 302 may be a percentage of all attempts to execute the gameplay skill that were successful. In the example shown in FIG. 3, the success rate 302 for the “blocking” skill is 12%. The node updater 116 may provide the updated success rate 302 to a gaming device 102 associated with the player profile and/or the associated application 104.

In some embodiments, the user interface 300 additionally or alternatively includes a graphical comparison 306 of the success rate to a target success rate 308. The target success rate 308 may be a goal or threshold success rate that a player is encouraged to achieve. The target success rate 308 may be set manually and/or may be based on an average success rate for player profiles in a certain Elo or matchmaking rating (MMR) range, for example.

A user interface (e.g., 300) for a skill node may also display a comparison of the success rate 302 to other players' success rates for the gameplay skill. The other players' success rates may be determined in accordance with any of the methods of determining a success rate described herein. The comparison may be a percentile, a numeric ranking, or a letter grade, to name a few examples. In some aspects, the success rate is compared to all—or a random sample of—the other players' success rates. In other aspects, the success rate is compared only to other players having a same or similar rank, Elo, and/or MMR. To illustrate, if the player's profile has a rank of Gold 2, the player's success rate could be compared to other Gold 2 players, other Gold 1-3 players, or Silver 1-Platinum 3 players, to name a few examples. However, in some aspects, the comparison may not be included in the user interface 300—e.g., may be hidden or locked—until the success rate reaches a threshold. These aspects are discussed in more detail below with respect to FIG. 4.

As briefly discussed with respect to FIGS. 2 and 3, skill nodes (e.g., as presented via user interface(s) 200 and/or 300) may include various statistics for the associated gameplay skill. But in some cases, presenting such statistics to a user may be counterproductive. To illustrate, suppose the application 104 is a fighting game. A user who is new to fighting games could be overwhelmed if presented with a bevy of statistics related to advanced skills (e.g., complicated combination attacks). Moreover, a brand-new user's success rate for any given gameplay skill is typically far below average, so the user may become discouraged if presented statistics related to their gameplay (e.g., “Your success rate for blocking is lower than 99% of other players.”). As such, user interest and engagement may be improved by selectively hiding and presenting statistical information in a skill node based, for instance, on a user's proficiency level (e.g., success rate) for the corresponding gameplay skill.

The flowchart 400 of FIG. 4 illustrates embodiments for presenting useful gameplay statistics in a user interface. As shown in FIG. 4, a skill node may progress from a first state 402 to a second state 404 to a third state 406. Generally, as the skill node progresses from one state to the next, more statistical information is presented to the user (e.g., via the user interface(s) 200 and/or 300). Among other benefits, this approach decreases the risk that a user will be confused, overwhelmed, or discouraged by gameplay statistics.

A skill node may progress from one state to a subsequent state when a condition associated with the former state is satisfied. In some aspects, the node updater 116 determines that the condition has been satisfied (e.g., for a player profile) based on the gameplay data 108 for the player profile. For example, the condition may be satisfied when a success rate for a gameplay skill reaches or exceeds a threshold, such as a target success rate.

In some embodiments—including the embodiment shown in FIG. 4—a skill node comprises three states. The first state 402 may be a “locked” state in which the skill node is not selectable. The first state 402 may be a first or default state in a sequence of node states. In this state, gameplay data associated with the corresponding gameplay skill may be tracked but not visible to the player. The skill node may contain a link or other reference to a tutorial related to the gameplay skill. The condition for progression from the first state 402 to the second state 404 may be completion of the tutorial. This configuration encourages players to develop basic gameplay knowledge and experience prior to observing and tracking their performance via skill nodes, for example. However, other conditions, such as a success rate for the gameplay skill exceeding a threshold, may also cause progression from the first state 402 to the second state 404. For instance, an experienced fighting-game player may already be familiar with basic gameplay mechanics (e.g., blocking), which may obviate the need to complete a tutorial before proceeding to subsequent node states. Accordingly, the node updater 114 may determine, while a skill node is in the first state 402, that a success rate exceeds a threshold, and automatically update the skill node to the second state 404 based on the determination.

In the second state 404, a skill node may include additional information and/or statistics compared to the first state 402. For example, the skill node may include a statistical visualization (e.g., a success rate), a target success rate and/or skill badges. These features may afford a player an opportunity to meaningfully evaluate their in-game performance in regard to the gameplay skill and/or identify ways to improve their gameplay. In the second state 404, the skill node may also include textual advance and/or links to replays of potions of their matches relevant to the skill; these features are discussed in more detail below with respect to FIGS. 5A-6. The skill node may progress from the second state 404 to the third state 406 based on the success rate reaching a threshold (e.g., a target success rate), for example.

In the third state 406, the skill node may include a comparison of the player's success rate to success rates of other players and/or additional statistics. As previously discussed, in some cases, less-experienced players may be discouraged by comparisons to other players. As such, delaying the visibility of player-to-player comparisons until a skill node reaches the third state 406—i.e., until the player has become more proficient at the skill—may improve player engagement. In some embodiments, the comparison is a letter grade (e.g., “A” or “B+”), percentile, or rank. And as previously discussed in regard to FIG. 3, the player may be compared to all other players, a random sample of active players, or only players having a same or similar rank, Elo, and/or MMR.

The additional statistics displayed in a third-state skill node can, for example, include trend information and/or more advanced/granular statistics for the gameplay skill. Trend information may be an indication of a change in the user's success rate over a period of time or number of matches—e.g., “Your blocking success rate improved by 5% over the last month.” The advanced statistics may include success rates for gameplay skill that are related to (e.g., subsets of) the gameplay skill for the skill node. For example, the third state 406 of the “blocking” skill node shown in FIG. 4 could display success rates for one or more sub-skills such as blocking aerial attacks, blocking low attacks, blocking combos, and so on.

In some embodiments, when a selected skill node reaches its final state (e.g., the third state 406), a different skill node may be selected. The selection may be performed manually (e.g., by the user at a gaming device 102) or automatically (e.g., by the gaming server 110). A node may be automatically selected when a user fails to manually select a different skill node.

In example embodiments featuring automatic skill node selection, it is determined that a condition associated with a penultimate state of the skill node has been satisfied. Based on the determination, a gameplay skill associated with a second skill node is identified. The gameplay skill may be identified based on a determination that a success rate for the gameplay skill is (a) below a threshold and/or (b) a lowest success rate of a plurality of success rates for a plurality of gameplay skills compared to success rates for other players. To illustrate case (b), if the player's success rate for a “normal attacks” gameplay skill is in the second percentile (i.e., is worse than the success rates of 98-99% of other players) and all of the player's success rates for other gameplay skills are comparatively higher, the “normal attacks” gameplay skill could be automatically selected.

Turning now to FIG. 5A, in many video games, a post-match user interface is presented following the conclusion of a match. Traditional post-match user interfaces include elements such as an indication of a match result (e.g., “You lost!”) and an indication of experience points (XP) the player has gained from the match. In addition to these elements, the training system 112 described herein may provide information related to a selected skill node for display in a post-match UI 500. Because users typically select skill nodes corresponding to gameplay skills at which they wish to improve, displaying gameplay skill-related information on the post-match UI 500 affords users the opportunity to quickly assess their gameplay-skill performance without navigating through additional menus or sifting through lists of irrelevant statistics.

In some embodiments, the post-match user interface 500 includes a success rate 502 for the gameplay skill associated with the selected skill node. The success rate 502 may be determined in accordance with any of the methods of determining a success rate described herein. But in some embodiments, the gameplay data used to determine the success rate 502 consists of gameplay data from the match that corresponds to the post-match UI 500. Put another way, the success rate 502 may be a success rate for the gameplay skill for only the match corresponding to the post-match UI 500.

In some aspects, the replay generator 118 generates a replay of a portion of a match. The replay—or a thumbnail 504 of and/or link to the replay—can be included in the post-match UI 500. At a high level, the replay may show a portion of the match corresponding to the gameplay skill for the selected skill node. For example, if the selected skill node corresponds to the “blocking” gameplay skill, the replay could be a portion of a match in which a user's character failed to properly block an enemy character's attack. This feature enables players to easily review and learn from past gameplay mistakes relevant to a gameplay skill of interest—e.g., without having to review full-match replays or meticulously analyze data.

FIG. 5B illustrates an example method 550 for providing a replay of a portion of a match, such as a replay corresponding to the replay thumbnail 504 of FIG. 5A. Some embodiments of method 550 may be performed by the replay generator 118 of FIG. 1 and/or other components depicted in FIG. 1. Each block of the method 550 and any other methods described herein comprises a computing process performed using any combination of hardware, firmware, and/or software. For instance, various functions may be carried out by a processor executing instructions stored in memory. The methods may also be embodied as computer-usable instructions stored on computer storage media. The methods may be provided by a standalone application, a service or hosted service (standalone or in combination with another hosted service), or a plug-in to another product, to name a few examples.

At step 552, it is determined that a match associated with a player profile has concluded. This determination may be based on a character in the match reaching zero health points (HP) or any other match-end condition, such as expiration of a timer. This determination may trigger generation (and, eventually, presentation at a gaming device) of a post-match user interface, such as the post-match UI 500 of FIG. 5A.

At step 554, a timestamp in the match at which a character associated with the player profile failed to properly execute a gameplay skill is determined. As previously discussed, gameplay data 108 comprising gameplay events (e.g., successful or unsuccessful attacks) may be generated for a match, and the gameplay events may be indexed or labeled based on the timestamp (e.g., frame or step) at which they occur. The replay generator 118 may parse the gameplay data for the match to identify one or more timestamps corresponding to the gameplay skill. In particular, the replay generator 118 may identify gameplay events (and/or timestamps thereof) at which the player's character failed to perform the gameplay skill. To illustrate, a gameplay event relevant to the “blocking” skill could be “Character B hit Character A with a normal attack; Character B's block attempt missed (blocked too early).” The replay generator 118 may ignore gameplay events that do not correspond to the gameplay skill and/or do not correspond to the player-controlled character. To illustrate, if the “blocking” skill node is selected for a player and “Character A” is controlled by the player, the replay generator would ignore gameplay events such as “Character A lands a low attack on Character B” (which is unrelated to the gameplay skill) and “Character B blocks Character A's normal attack” (since the block was not performed by Character A).

At step 556, based on the match having concluded, a replay (e.g., a video) of a portion of the match corresponding to the timestamp is provided for display (e.g., at a gaming device corresponding to the player). The replay may be rendered by the gaming server 110 based, for example, on the gameplay data for the match. The replay may include the gameplay event selected by the replay generator 118 and a fixed interval of time surrounding the selected gameplay event. As an example, the replay may be about ten seconds long—e.g., five seconds leading up to the selected gameplay event, the moment at which the gameplay event occurs, and five seconds following the selected gameplay event. A thumbnail image for the replay 504 (which may be a frame of the replay corresponding to the selected gameplay event), a link to the rendered replay, and/or the replay itself may be provided at the post-match UI 500.

Returning now to FIG. 5A, the training system 112 may provide, in the post-match UI 500, textual advice 506 related to the gameplay skill. Although described herein as “textual” advice, it is contemplated that such advice can, alternatively or additionally, be communicated in other forms—e.g., audio. At a high level, the training system 112 may identify a potential area of improvement relevant to the gameplay skill and advise the player accordingly. To do so, the training system 112 may analyze gameplay events in which the player's character failed to properly execute the gameplay skill (e.g., missed a block), which are referred to below as “failures.”

In some aspects, the training system 112 analyzes spatial information regarding failures and provides corresponding textual advice. As used herein, the term “spatial information” refers to information related to spatial locations of one or more objects (e.g., characters) in a gaming environment. For example, the training system 112 may determine that a gameplay skill would have been executed successfully if a character associated with the player profile had performed the action at a different spatial location. For example, for the “blocking” gameplay skill, the training system 112 may determine that a disproportionately high number of the player's blocking-related failures in the match corresponded to low attacks. Corresponding advice may be provided for display in the post-match UI 500, as shown in FIG. 5A. The same concept applies to other gameplay skills. For instance, if the selected skill node corresponds to the “normal attacks” gameplay skill, the textual advice could be “Most of your aerial attacks are missing. Check out this tutorial for tips on executing aerial attacks.”

In some aspects, the training system 112 analyzes timing-related information regarding failures and provides corresponding textual advice. More specifically, the failures may be analyzed to determine whether unsuccessful attempts to execute the gameplay skill result from an input (e.g., keypress) that is too early or too late. For example, for the “blocking” gameplay skill, the training system 112 may determine that a disproportionately high number (e.g., most) of the player's unsuccessful block attempts (e.g., keypresses corresponding to a “block” key or button) occurred after a range of steps or frames in which a block could have been successfully executed. In this situation, the textual advice could be “Most of your block attempts are too late. Check out this tutorial for tips on timing blocks.”

The training system 112 may alternatively or additionally provide other types of gameplay feedback based on analysis of gameplay data (e.g., based on identifying a failure and/or determining that a success rate is below a threshold). In some embodiments, the training system 112 provides a gameplay exercise. A gameplay exercise may comprise a virtual environment in which a player-controlled character is guided through one or more steps related to successfully executing a gameplay skill. In another example, the training system 112 provides a training match against a computerized opponent. The training match may be configured such that the computerized opponent provides a player-controlled character one or more opportunities to execute a particular gameplay skill. For instance, a training match may provide a player an opportunity to practice blocking attacks (or a particular type of attack). As another example, the training system 112 may provide a training challenge related to a gameplay skill. The training challenge may be similar to a training match but may not comprise a computerized opponent. Instead, a training challenge could, for example, afford a player-controlled character an opportunity to practice attacks against a stationary target.

Turning now to FIG. 6, an illustration 600 is provided showing a process for generating and providing gameplay feedback—at least partially in accordance with aspects previously discussed in regard to FIGS. 5A-5B. At a high level, gameplay events are detected during a match (step 602), the match concludes (step 604), and feedback (e.g., advice) based on the gameplay events is presented at a post-match UI. In this manner, the user's gameplay skills may be iteratively improved over the course of a plurality of matches.

At step 602, gameplay events are detected during a match. The match may be a gameplay instance hosted on the gaming server 110. The match may include a plurality of players (e.g., 2-4 players). Each player may engage in the match via an application 104 on a respective gaming device 102 connected to the server. The users may provide inputs at their respective gaming devices 102 that cause corresponding virtual characters to perform various actions, such as attacking or blocking. Each of the players may be associated with a player profile, which may be (or comprise) a unique profile ID that identifies the player and/or their account. Any or all of the player profiles may have a selected skill node corresponding to a gameplay skill.

However, as mentioned above, it is contemplated that the gameplay events and gameplay data detected at step 602 may not (or may not entirely) be derived from remotely hosted PVP matches. For example, gameplay data may be detected from local gameplay matches, gameplay exercises, training matches (e.g., against a computerized opponent), training challenges, or any combination thereof. Any of these potential sources of non-PvP gameplay data may be detected on a remote gaming server or locally on a gaming device—e.g., not on a gaming server.

As the match progresses, gameplay data is generated and stored in the datastore 108. The gameplay data may comprise a plurality of gameplay events, such as successful/unsuccessful attacks, blocks, and combos; player movements; and so on. In the example shown at step 602 of FIG. 6, one character is shown performing an unsuccessful combo—i.e., a combo that does not do damage to the opponent's character or does not do the maximum possible damage to the opponent's character. A corresponding gameplay event—e.g., “Player A performs an unsuccessful combo”—could be recorded in the gameplay data.

At step 604, the match concludes. A determination that the match has concluded may be based on a character in the match reaching zero HP or any other match-end condition, such as expiration of a timer.

As illustrated at step 606, following the conclusion of the match, a post-match UI is generated (e.g., by the gaming server 110) and presented to a corresponding player—e.g., via the application 104 on the gaming device 102 corresponding to the player. As previously discussed with respect to FIGS. 5A-5B, the post-match UI may comprise a replay (or a thumbnail and/or link thereto) of a portion of the match in which the player's character failed to properly execute the gameplay skill. The post-match UI may also include textual advice related to the gameplay skill. In the example shown in FIG. 6, the selected skill node corresponds to the “combos” gameplay skill. Accordingly, as shown at step 606, the post-match UI includes a thumbnail of (and a link to) a replay of the portion of the match shown at step 602—i.e., where the player's character failed to properly execute a combo. Similarly, the post-match UI includes textual advice that notes that the player “only connected on 7% of [their] combos” and provides a link to a tutorial on executing combos.

FIG. 7 illustrates an example method 700 for analyzing and providing feedback on gameplay. One potential drawback of allowing players to manually select skill nodes is that a player-selected skill node may not correspond to a gameplay skill most critical to the player's success. To illustrate, a player may select a “combos” skill node but lose most of their matches due primarily to failing to block their opponents' attacks. Accordingly, in contrast to some other embodiments described herein, the method 700 provides gameplay feedback based on gameplay data (e.g., instead of manual skill-node selection).

At step 710, a match is facilitated. The match may be facilitated by (e.g., hosted on) a gaming server, such as the gaming server 110 of FIG. 1. The match may comprise any of the characteristics of a match described herein. For example, the match may comprise characters controlled by inputs received from one or more gaming devices.

At step 720, gameplay data for the match is analyzed to determine a skill node for a player profile. The determined skill node may be a skill node for which the player profile has a lowest success rate (relative to success rates for the player profile for other skill nodes). In some embodiments, the success rate is based only on the gameplay data for the match; in other embodiments, the success rate is based on gameplay data for a plurality of most-recent matches.

In other embodiments, the skill node is determined based on a downward trend in a success rate for the skill node. For example, a first success rate for the gameplay skill corresponding to the skill node may be determined based on gameplay data for one or more most-recent matches for the player profile, including the match facilitated at step 710. A second success rate for the gameplay skill may be determined based on gameplay data for matches that took place prior to the most-recent matches. This process may be repeated for a plurality of skill nodes (e.g., all “unlocked” skill nodes). Differences between corresponding first and second success rates may be calculated—either in absolute or relative terms. (To illustrate, an increase from a 5% success rate to a 10% success rate could be viewed either as a 5% increase or a two-times improvement in success rate.) A skill node may be determined based on having the lowest difference—i.e., the most negative trend in success rate from the less-recent matches to the most-recent matches.

At step 730, feedback is provided based on the determined skill node. The feedback may be provided at a gaming device corresponding to the player profile. For example, the feedback may be presented in a post-match interface—e.g., a post-match interface for the match facilitated at step 710. In some embodiments, the feedback comprises a success rate, textual advice, and/or any other type of feedback previously described herein. Alternatively or additionally, the feedback may comprise a prompt to visit a user interface associated with the determined skill node, such as the user interface 300 previously described in connection with FIG. 3. Additionally, or alternatively, the prompt may comprise a link to a training module associated with the gameplay skill, skill node, or both.

As depicted in FIGS. 6 and 7, the aspects described herein facilitate context sensitive player training. At least one advantage that may be realized by deploying the systems, methods, and processes described herein is the dynamic nature of the player's training experience. As mentioned above, traditional tutorials focus on one specific action or overload a player with every possible action. The systems, methods, and processes described herein identify opportunities for the player to “improve” based on the player's gameplay. The gameplay skills (e.g., input combinations, timing, positioning, and so forth) associated with the relevant skill nodes are identified and training is presented to the player that is relevant to those gameplay skills. If the player's success rate crosses the respective threshold for the skill(s) associated with the skill node, other opportunities for the player to “improve” are identified. Training is presented to the player relevant to the other opportunities and the training process continues. Further, if over time the player's gameplay regresses for a particular skill, the relevant skill node is identified and the opportunity for training is provided for the regressed skill. Accordingly, the aspects described herein facilitate context sensitive training based on the player's gameplay. The training is dynamically adjusted as the player's demonstrated ability changes over time.

### Example Operating Environment

Having described implementations of the present disclosure, an example operating environment in which embodiments of the present technology may be implemented is described below in order to provide a general context for various aspects of the present disclosure. Referring to FIG. 8, an example operating environment for implementing embodiments of the present technology is shown and designated generally as computing device 800. Computing device 800 is but one example of a suitable computing environment and is not intended to suggest any limitation as to the scope of use or functionality of the technology. Neither should the computing device 800 be interpreted as having any dependency or requirement relating to any one or combination of components illustrated.

The technology may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The technology may be practiced in a variety of system configurations, including hand-held devices, consumer electronics, general-purpose computers, more specialty computing devices, etc. The technology may also be practiced in distributed computing environments where tasks are performed by remote-processing devices that are linked through a communications network.

With reference to FIG. 8, computing device 800 includes bus 810 that directly or indirectly couples the following devices: memory 812, one or more processors 814, one or more presentation components 816, input/output (I/O) ports 818, input/output components 820, and illustrative power supply 822. Bus 810 represents what may be one or more buses (such as an address bus, data bus, or combination thereof). Although the various blocks of FIG. 8 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors recognize that such is the nature of the art, and reiterate that the diagram of FIG. 8 is merely illustrative of an example computing device that may be used in connection with one or more embodiments of the present technology. Distinction is not made between such categories as “workstation,” “server,” “laptop,” “hand-held device,” etc., as all are contemplated within the scope of FIG. 8 and reference to “computing device.”

Computing device 800 typically includes a variety of computer-readable media. Computer-readable media may be any available media that may be accessed by computing device 800 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 800. Computer storage media does not comprise signals per se. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 812 includes computer storage media in the form of volatile and/or nonvolatile memory. The memory may be removable, non-removable, or a combination thereof. Example hardware devices include solid-state memory, hard drives, optical-disc drives, etc. Computing device 800 includes one or more processors that read data from various entities such as memory 812 or I/O components 820. Presentation component(s) 816 present data indications to a user or other device. Example presentation components include a display device, speaker, printing component, vibrating component, etc.

I/O ports 818 allow computing device 800 to be logically coupled to other devices including I/O components 820, some of which may be built in. Illustrative components include a microphone, joystick, game pad, satellite dish, scanner, printer, wireless device, etc. The I/O components 820 may provide a natural user interface (NUI) that processes air gestures, voice, or other physiological inputs generated by a user. In some instances, inputs may be transmitted to an appropriate network element for further processing. A NUI may implement any combination of speech recognition, touch and stylus recognition, facial recognition, biometric recognition, gesture recognition both on screen and adjacent to the screen, air gestures, head and eye-tracking, and touch recognition associated with displays on the computing device 800. The computing device 800 may be equipped with depth cameras, such as, stereoscopic camera systems, infrared camera systems, RGB camera systems, and combinations of these for gesture detection and recognition. Additionally, the computing device 800 may be equipped with accelerometers or gyroscopes that enable detection of motion.

The present technology has been described in relation to particular embodiments, which are intended in all respects to be illustrative rather than restrictive. Alternative embodiments will become apparent to those of ordinary skill in the art to which the present technology pertains without departing from its scope.

Having identified various components utilized herein, it should be understood that any number of components and arrangements may be employed to achieve the desired functionality within the scope of the present disclosure. For example, the components in the embodiments depicted in the figures are shown with lines for the sake of conceptual clarity. Other arrangements of these and other components can also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, and/or software, as described below. For instance, various functions may be carried out by a processor executing instructions stored in memory. As such, other arrangements and elements (e.g., machines, interfaces, functions, orders, and groupings of functions) may be used in addition to or instead of those shown.

Embodiments described herein may be combined with one or more of the specifically described alternatives. In particular, an embodiment that is claimed may contain a reference, in the alternative, to more than one other embodiment. The embodiment that is claimed may specify a further limitation of the subject matter claimed.

The subject matter of embodiments of the technology is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” can be used herein to connote different elements of methods employed, the terms should not be interpreted as implying any particular order among or between various steps herein disclosed unless and except when the order of individual steps is explicitly described.

For purposes of this disclosure, the word “including” has the same broad meaning as the word “comprising,” and the word “accessing” comprises “receiving,” “referencing,” or “retrieving.” Further, the word “communicating” has the same broad meaning as the word “receiving,” or “transmitting” facilitated by software or hardware-based buses, receivers, or transmitters using communication media described herein. In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

For purposes of a detailed discussion above, embodiments of the present technology are described with reference to a distributed computing environment; however, the distributed computing environment depicted herein is merely an example. Components can be configured for performing novel embodiments of embodiments, where the term “configured for” can refer to “programmed to” perform particular tasks or implement particular abstract data types using code. Further, while embodiments of the present technology can generally refer to the technical solution environment and the schematics described herein, it is understood that the techniques described can be extended to other implementation contexts.

From the foregoing, it will be seen that this technology is one well adapted to attain all the ends and objects set forth above, together with other advantages which are obvious and inherent to the system and method. It will be understood that certain features and subcombinations are of utility and can be employed without reference to other features and subcombinations. This is contemplated by and is within the scope of the claims.

We claim:

1. A computer-implemented method for recommending skill nodes for a player profile, the method comprising:
determining that a condition associated with a first skill node has been satisfied, the first skill node corresponding to a first gameplay skill associated with the player profile;
identifying a second skill node corresponding to a second gameplay skill based on the determination that the condition has been satisfied, the second gameplay skill being different than the first gameplay skill; and
based on the second skill node being identified, automatically recommending for the player profile a selection of the second skill node at a user interface.

2. The computer-implemented method of claim 1, the second skill node being identified based on a success rate for the second gameplay skill associated with the player profile.

3. The computer-implemented method of claim 2, the second skill node being identified based on the success rate being below a threshold.

4. The computer-implemented method of claim 2, the success rate being determined based on player-versus-player (PvP) gameplay data for the player profile.

5. The computer-implemented method of claim 1, further comprising:
receiving a selection of the second skill node via the user interface; and
based on the selection being received, displaying statistical information for the second gameplay skill for the player profile.

6. The computer-implemented method of claim 4, the statistical information comprising the success rate for the second gameplay skill.

7. The computer-implemented method of claim 1, wherein determining that the condition associated with the first skill node has been satisfied comprises determining that a success rate for the first gameplay skill associated with the player profile is above a threshold.

8. A computer-implemented method comprising:
analyzing gameplay data corresponding to a gameplay skill, the gameplay skill being associated with a player profile;
receiving a selection of a skill node, wherein the skill node is associated with the gameplay skill; and
based on the selection and the analyzed gameplay data, providing for display a content recommendation associated with the gameplay skill.

9. The computer-implemented method of claim 8, the content recommendation comprising a recommendation to complete a gameplay exercise related to the gameplay skill.

10. The computer-implemented method of claim 8, the content recommendation comprising a recommendation to complete a training match against a computerized opponent, the training match being related to the gameplay skill.

11. The computer-implemented method of claim 8, the content recommendation comprising textual advice related to the gameplay skill.

12. The computer-implemented method of claim 8, the content recommendation being provided for display at a post-match user interface, and the analyzed gameplay data comprising gameplay data for a match corresponding to the post-match user interface.

13. The computer-implemented method of claim 8, wherein the gameplay data comprises player-versus-player (PvP) gameplay data.

14. The computer-implemented method of claim 13, wherein the PvP gameplay data comprises data derived from a fighting game played over the internet.

15. Non-transitory computer storage media storing executable instructions that when executed by one or more processors cause the processors to perform a method comprising:
analyzing gameplay data corresponding to a gameplay skill, the gameplay skill being associated with a player profile;
receiving a selection of a skill node, wherein the skill node is associated with the gameplay skill; and
based on the selection and the analyzed gameplay data, providing for display a content recommendation associated with the gameplay skill.

16. The computer storage media of claim 15, wherein the content recommendation comprises a recommendation to complete a gameplay exercise related to the gameplay skill.

17. The computer storage media of claim 15, the content recommendation comprising a recommendation to complete a training match against a computerized opponent, the training match being related to the gameplay skill.

18. The computer storage media of claim 15, the content recommendation comprising textual advice related to the gameplay skill.

19. The computer storage of claim 15, the content recommendation being provided for display at a post-match user interface, and the analyzed gameplay data comprising gameplay data for a match corresponding to the post-match user interface.

20. The computer storage of claim 15, wherein the gameplay data comprises player-versus-player (PvP) gameplay data.
